(19) United States
(12) Patent Application Publication
(10) Pub. No.: US 2007/0065563 A1
(43) Pub. Date: Mar. 22, 2007

(54) Process for the preparation of an edible emulsion

(76) Inventors: Freek Reckweg, Hellbronn (DE); Christel Karine Reiffers-Magnani, Vlaardingen (NL); Cornelis van Vliet, Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 10/567,049

(22) PCT Filed: Jul. 9, 2004
(86) PCT No.: PCT/EP04/07616

§ 371 Date: Aug. 3, 2006

(30) Foreign Application Priority Data
Aug. 4, 2003 (EP) 03077428.5

(51) Int. Cl. A23D 7/00

(52) U.S. Cl. 426/602

(57) ABSTRACT

The invention provides a process for the preparation of an edible emulsion having a reduced oxidative metal content which comprises an oil phase and an aqueous phase, the process comprising the steps of (a) providing a starting material containing a protein material; (b) removing metal from the starting material; and (c) using the product of step (b) to form an edible emulsion. An edible emulsion obtainable by such a process and a food product comprising such an edible emulsion are also provided.

### FIELD OF THE INVENTION

The invention relates to a process for the preparation of an edible emulsion having a reduced oxidative metal content, an edible emulsion obtainable by such a process and a food product comprising such an edible emulsion. The invention also relates to a skimmed milk powder, a butter milk powder and a whey protein isolate which all have a reduced iron and/or copper content.

### BACKGROUND OF THE INVENTION

In the case of edible emulsions which comprise an oil phase and an aqueous phase, metal ion catalysed lipid oxidation is known to be one of the major causes of reduced product shelf life. Essentially, the presence of metal ions catalyses the oxidation of both saturated and unsaturated fats promoting the formation of an off-flavour and rancidity. However, polyunsaturated fatty acids are particularly sensitive to metal ion catalysed oxidation. This problem is particularly prevalent in dairy products, that is, products which contain milk or a component or derivative thereof, and, especially, dairy alternatives, that is, spreads, creams and drinks in which the dairy fat and/or protein have been partially or totally replaced by vegetable fat and/or protein.

Milk is a complex biological product that contains many compounds acting as anti- and/or pro-oxidants. Among the pro-oxidants in milk, the transition metal ions of copper and iron are known to play a key role in milk fat oxidation. Although milk contains much more iron than copper (100-900 μg I⁻¹ versus 20-400 μg I⁻¹) and the standard reduction potential of Fe³⁺ suggests that it is a much stronger oxidising agent than Cu²⁺, different studies reveal that copper is the principal catalytic metal in lipid oxidation. This has been explained by different interactions of the two metals with other milk constituents (e.g. ascorbic acid, thiols or phosphate residues). However, the total endogenous copper content in milk does not appear to be the key factor in oxidation, as it has been found that oxidation via copper already occurs above a threshold value of 0.06 ppb.

Endogenous milk copper and iron form complexes with proteins, peptides, carbohydrates, fats and small molecules like citrate and amino acids via specific and non-specific binding sites. In skimmed milk, 50-65% of the iron is bound to casein, 18-33% to whey proteins and the remainder to non-protein material such as citric acid, orotic acid and inorganic phosphate. Lactoferrin, a whey protein, has two Fe³⁺ binding sites with an affinity of 1×10⁻²⁸ (affinity for Fe²⁺ and copper is much lower), provided sufficient amounts of the cofactor carbonate are present. Copper is also mainly bound to casein, as 1 mole micellar casein can bind 67 mole of copper, whereas 1 mole β-lactoglobulin can only bind 2.5 mole. Serum albumin, a whey protein, is able to bind copper with an affinity of 2×10⁻¹⁶ via a specific binding site.

When bound to a protein, binding can be rather specific and the metal ion is not dialysable at neutral conditions. Caseins are known to bind metal ions by their serine bound phosphate (Pser), as well as their tyrosine, glutamic acid and aspartic acid residues. Binding of iron to the Pser group, especially the four high affinity Pser groups of alpha and beta-casein, probably takes place by strong co-ordination bonds as it has been found that neither heat nor pH, nor the presence of Na₂HPO₄, is able to liberate the metal. In contrast, the binding of, for instance, calcium to Pser takes place by much weaker ionogenic bonds. Also, the binding affinity of the metal-amino acid complexes are much lower as it is known that a decreased pH, and subsequently an increased proton concentration, will compete with the metals for the ionisable groups on these cation protein binding sites.

Ligands associated with transition metals can exert a profound influence on the catalytic properties of the bound metal. The formation of iron-casein complexes induces the oxidation of iron from the ferrous (Fe²⁺) to the ferric (Fe³⁺) state which is known to be less catalytic. Constituents of foods that reduce Fe³⁺ (or Cu²⁺), like ascorbic acid or thiols, may accelerate the lipid oxidation again. The casein-copper complex is known to inhibit copper catalysed fat oxidation and, recently, it has been found that caseinophosphopeptides can act as natural chelators to inhibit lipid oxidation. On the other hand, the major whey proteins, β-lactoglobulin and alpha-lactalbumin, bind copper and iron (probably by the carboxylic groups of glutamic acid and aspartic acid) to a much lower extent, whereas their dissociation is influenced by proton concentration.

During the production of dairy spread alternatives, high temperature (up to 85° C.) in combination with acidification to low pH will change the protein structure with the result that the catalytic activity of metals on oxidation may be enhanced. Moreover, the presence of milk proteins at the oil-water interface can promote the exposure of metal to the fat phase and thus enhance the oxidation process. In addition, during acidification, (some of) the metals associated with carboxylic groups of glutamic acid and aspartic acid may be liberated and available for further oxidation.

At present, the most efficient solution to the problem of metal ion catalysed lipid oxidation is to include ethylenedinitrilo tetraacetic acid (EDTA) in vulnerable edible emulsions. EDTA is a simple and cost effective metal chelator that eliminates the catalytic lipid oxidation effect caused by both copper and iron. However, legislative restrictions in the field of nutrition and the desire for green labelling of products will reduce the admissibility of this sequestrant in many countries in the coming years. Moreover, other food-grade sequestrants and anti-oxidants are not as effective as EDTA in dairy products and dairy alternatives.

Furthermore U.S. Pat. No. 2,847,308 discloses a method of metal removal wherein heavy metal such as copper and iron is removed by contacting the food product with the calcium salt of the calcium chelate or the dihydrogen calcium chelate of a compound which is an organic acid derivative of ammonia. The entire final food product is contacted with this composition. The removal of copper or iron is accompanied by a simultaneous increase in calcium content.

EP-A-233565 discloses spreads produced from deminaralised, deacidified milk. The minerals removed are e.g. potassium, sodium, magnesium, calcium.

In view of the above, it is an object of the present invention to provide an alternative method for reducing metal ion catalysed lipid oxidation in edible emulsions and thereby increase product shelf life.

### SUMMARY OF THE INVENTION

It has now been surprisingly found that oxidative metals can be removed from the protein-containing starting materials used to form such edible emulsions, especially protein powders, without affecting the functional properties of the proteins. Since such protein-containing starting materials are a major source of oxidative materials, edible emulsions made from such starting materials having a reduced metal content will be less susceptible to metal ion catalysed lipid oxidation.

According to the present invention there is therefore provided a process for the preparation of an edible emulsion having a reduced oxidative metal content which comprises an oil phase and an aqueous phase, the process comprising the steps of
(a) providing a starting material containing a protein material;
(b) removing metal from the starting material; and
(c) using the product of step (b) to form an edible emulsion.

In another aspect, the invention provides an edible emulsion obtainable by this process.

In a further aspect, the invention provides a food product comprising such an edible emulsion.

### DETAILED DESCRIPTION OF THE INVENTION

In the context of the invention, the terms “fat” and “oil” are used interchangeably. The term oil encompasses both triglyceride oils and diglyceride oils.

For the purpose of the present invention, wt % is defined as weight percent on total product weight unless otherwise indicated.

The invention concerns the preparation of an edible emulsion having a reduced content of oxidative metals, especially copper and iron. As mentioned above, the process involves the steps of providing a starting material comprising a protein material, removing metal from the starting material and using the resultant product to form an edible emulsion by conventional methods. Metal removal may be partial or total metal removal. The starting material may also include at least one thickener.

The protein material may be a protein or a fraction or a hydrolysate thereof. The term “protein fraction” refers to a part of a protein which has been obtained by a physical treatment of a protein, for instance, via a physical separation technique. The term “protein hydrolysate” refers to a part of a protein, such as a peptide, which has been obtained by a chemical treatment, for instance, using an enzyme to cut the protein into smaller fragments.

The protein may be any animal or vegetable protein, including fungal or bacterial protein, or a combination thereof. However, it is preferred that the protein is selected from the group consisting of milk proteins, soya protein, pea protein, lupin protein, rice protein, fungal protein and combinations thereof, especially milk proteins, soya protein, pea protein and combinations thereof.

It is particularly preferred that the protein is a milk protein. Suitable sources of milk protein as starting material include whole milk, whole milk powder, skimmed milk, skimmed milk powder, butter milk, butter milk powder, butter serum, butter serum powder, whey, whey powder, whey protein concentrate, whey protein isolate and sodium caseinate. Skimmed milk powder, butter milk powder and whey protein concentrates are especially preferred as starting materials.

Using the process of the invention, it is possible to remove from 25 wt % to 100 wt % of the oxidative metals such as copper and iron, in the starting material. In the case of copper, it is preferred that up to 90% wt %, preferably up to 85 wt %, of the copper in the starting material is removed. In the case of iron, it is preferred that up to 65 wt %, preferably up to 60 wt %, of the iron in the starting material is removed.

It will be appreciated that the quantity of metal remaining in the starting material after treatment according to steps (a) and (b) of the process of the invention will depend to some exent on the quantity of metal present in the original, untreated starting material. The quantity of metal present in the untreated starting material varies considerably according to the type of starting material. For instance, skimmed milk powder typically contains from 3 to 6 ppm iron and from 0.5 to 1.8 ppm copper based on protein content. However, butter milk powder typically contains from 18 to 25 ppm iron and from 1.5 to 2.5 ppm copper and whey protein concentrate typically contains from 11 to 13 ppm iron and from 0.9 to 1.3 ppm copper based on protein content. If these starting materials are treated according to steps (a) and (b) of the process of the invention, the quantities of iron and copper present can be significantly reduced. Thus, skimmed milk powder can be obtained which has an iron content in the range of 1 to 2.5 ppm, preferably 1.2 to 2.4 ppm, and/or a copper content in the range of 0.05 to 0.3 ppm, preferably 0.075 to 0.27 ppm, based on protein content. Butter milk powder can be obtained which has an iron content in the range of 1 to 15 ppm, preferably 1 to 9 ppm, and/or a copper content in the range of 0.05 to 0.5 ppm, preferably 0.05 to 0.4 ppm, based on protein content. Similarly, whey protein concentrate can be obtained which has an iron content in the range of 4 to 6 ppm, preferably 4.4 to 5.2 ppm, and/or a copper content in the range of 0.1 to 0.2 ppm, preferably 0.135 to 0.195 ppm, based on protein content. Such starting materials having a reduced iron and/or copper content also form part of the invention.

Removal of oxidative metals such as copper and iron, can be accomplished by any one of a variety of separation techniques known to those skilled in the art or by a combination of such techniques. These techniques can be roughly divided into specific and non-specific ways to remove metal ions. Preferred techniques included filtration, preferably ultrafiltration, dialysis, preferably electrodialysis, and chromatographic separation.

Ultrafiltration techniques are commonly used in the dairy industry to prepare whey protein isolates and lactose and are popular because they are cost effective and can be easily scaled up. Ultrafiltration is a non-specific way to remove components with a small molecular size, as separation occurs via a membrane with a specific molecular weight cut-off. Consequently, not only the metal ions will be removed when this technique is used, but also other small molecules like lactose and salts, which might have to be re-added afterwards to maintain product quality. As metals are hardly removed under neutral conditions, it is preferred to carry out ultrafiltration under acidic conditions, optionally at increased temperature, optionally in the presence of a chelator such as EDTA and/or in the presence of a reductant like ascorbic acid.

The preferred conditions for ultrafiltration in the method according to the invention are as follows.

According to one embodiment, for the removal of copper the pH of the ultrafiltration step is preferably less than 2, more preferred less than 1.5. It is preferred that the temperature is in the range of from 20 to 30° C.

According to another embodiment, for the removal of iron, the pH is preferably from 2.5 to 3, more preferred around 3. It is preferred that the temperature is in the range of from 20 to 30° C. To further improve the iron removal it is preferred to add ascorbic acid.

Optionally the ultrafiltration is carried out in the presence of EDTA. In that embodiment, it is preferred that the protein composition is preheated to a temperature within the range of about 65 to 90° C., more preferred about 70 to 80° C. Preferably the ultrafiltration is carried out within the same temperature range.

Other demineralisation processes developed by the dairy industry to extend their range of products permit a more specific removal of minerals from whey and whey permeates. These processes include nano-filtration (‘loose’ reverse osmosis), electrodialysis, mineral precipitation and ion-exchange chromatography.

The most specific and preferred way to remove metals from milk and whey leaving other small molecular weight substances like lactose and fatty acids undisturbed involves chromatographic separation. Various different chromatographic resins with a strong cation binding group linked via a spacer arm to polyacrylamide or agarose (Sepharose) based beads can be used. These have an average size of about 100 pm and can be easily separated from milk proteins using a glass filter. Suitable chromatographic resins include hydroxyapetite, sulphopropyl-, thiopropyl- and chelating Sepharose. Immobilised metal affinity chromatography (IMAC) using chelating Sepharose is particularly advantageous as these beads, containing part of an EDTA molecule, are specially designed for metal binding. Also, chromatographic resins containing (immobilised) sulphydryl (thiol) groups are known to specifically bind metals. Sulphopropyl Sepharose and thiopropyl Sepharose are particularly useful in this respect. Thiosuccinylated aminoethyl cellulose can also be used.

Bioscavenging of heavy metals from waste water has been accomplished using rice bran and this may also be useful for the separation of metals from milk. Instead of rice bran, numerous other compounds like peanut skins, walnut meal, wool, onion skin, waste tea leaves, etc. can also be used.

The edible emulsion produced by the process of the invention comprises an oil phase and an aqueous phase. The edible emulsion may be an oil-in-water emulsion or a water-in-oil emulsion.

Oil-in-water emulsions comprise an aqueous phase as the continuous phase and an oil phase as the dispersed phase. Also covered are products comprising more than one dispersed (oil) phase and products in which the dispersed oil phase comprises a dispersed phase itself. Such oil-in-water emulsions typically comprise from 1 to 80 wt % fat, preferably 1 to 50 wt % fat, more preferably 5 to 40 wt % fat.

Water-in-oil emulsions comprise an oil phase as the continuous phase and an aqueous phase as the dispersed phase. The fat phase of such a water-in-oil emulsion may constitute up to 95 wt % of the emulsion, preferably no more than 82 wt % of the emulsion. More commonly, the fat phase constitutes up to 60 wt % of the emulsion and, in low fat emulsions which are suitable as low fat spreads, up to 40 wt %.

Preferred products are characterised by a pH of the aqueous phase which is acidic. It was found that such products are more susceptible to oxidation than neutral products. Preferred products have a pH of from 4 to 6, more preferred from 4 to 5.2, even more preferred from 4.2 to 4.8.

The emulsion can be used as a final product and may be sold as such. Alternatively, the emulsion may be included in a food product.

The emulsion may be prepared separately and then included in the food product, but alternatively the emulsion is prepared in situ during the preparation of the food product.

Food products in which the emulsion may suitably be incorporated are preferably selected from the group comprising dairy products, such as milk, cheese, yoghurt, cream, ice cream, spreadable products such as margarine, butter, low fat spreads, sauces, dressings and mayonnaise.

Food products including an oil-in-water emulsion preferably include milk, cheese, yoghurt, cream, spreads, mayonnaise, dressings, sauces, ice cream and dairy alternative products. Food products including a water-in-oil emulsion preferably include margarine and low fat spreads.

Examples of emulsions which may be prepared by the process according to the invention using the specific oxidative metal-reduced protein sources are for example disclosed in EP-A-841856, EP-A-731644 and WO-A-03/043430.

The oil or fat used may be dependent on the type of product. Preferably, the fat is a vegetable fat, an animal fat, such as a dairy fat, or a combination thereof. Pure vegetable fat or combinations of vegetable fat and dairy fat are especially preferred because the problem of fat oxidation is especially encountered in these products and at least partly overcome by the process of the current invention. In particular, the fat may be either a vegetable oil, animal oil or a marine oil or a combination thereof. The fat is preferably selected from the group consisting of sunflower oil, safflower oil, palm oil, palm kernel oil, soybean oil, coconut oil, dairy fat such as butter fat, rapeseed oil, olive oil, peanut oil or oils extracted from plant or flower material such as rose oil, and combinations thereof. Fully or partially hardened fractions of such oils are also encompassed in the invention. Optionally, the fat may be an interesterified fat blend.

The emulsion may further comprise optional ingredients such as salt, flavour components such as herbs and spices, colourants, emulsifiers, preservatives, acidifying agents, sweeteners, (co)-oxidants such as hydrogen peroxide, and the like. Suitable emulsifiers include monoglycerides (saturated or unsaturated), diglycerides and phospholipids such a lecithins. In addition, the emulsion may contain sterols and/or stanols, preferably phytosterols and/or phytostanols and their corresponding esterified derivatives.

The amount of protein in the emulsion is preferably from 0.05 to 15 wt %, more preferably from 2 to 10 wt %, especially from 2 to 6 wt %.

The invention is further illustrated by the following non-limiting examples.

### EXAMPLES

Materials and Methods

1. Proteins and Sequestrants

Skimmed milk powder (SMP) was obtained from Coberco (SMP-medium heat) and whey protein concentrate (WPC) was obtained from Arla Food (Nutrilac QU7560). Ethylenedinitrilo tetraacetic acid or Titriplex III (EDTA) was obtained from Merck (1.08418), citric acid from Fisher (C/6200/53), Na₄P₂O₇ from Merck (6591 pro-analysis), ascorbic acid from Sigma (A-5960 Sigma ultra 99%) and phytic acid from Aldrich (27,432-1).

2. Element Analysis Using Plasma Emission or Atomic Absorption Spectroscopy

Both total and free transition metals in SMP and WPC were analysed using plasma emission spectroscopy analysis. For total metal analysis, the protein powders (0.5 g) were digested in 10 ml 65% nitric acid and 0.5 ml 30% hydrogen peroxide in closed vessels in a microwave oven at high temperature (ramp time 15 minutes and hold time 10 minutes at 200° C.) and high pressure (55 bar). After digestion, the solution was diluted to 1.4N nitric acid using demineralised water and sprayed into the inductively coupled plasma of a plasma emission spectrometer (Perkin Elmer 3300 DV Inductive Coupled Plasma-Optical Emission Spectrometer). The emission of the individual elements was measured at specific wavelengths (238.20 nm for iron and 324.75 nm for copper) and concentrations were quantified from standard solutions. The amount of free metals was calculated as mg/kg powder or mg/kg protein.

### Example 1

Small Scale Ultrafiltration

General Method

A small-scale (15 ml) ultrafiltration unit from Amicon (Centriprep YM3) was used containing a membrane with a molecular weight cut off (MWCO) of 3,000 Dalton. The polystyrene filter units were washed with 1 N HCl overnight and subsequently rinsed with demineralised water and dried. A 6.7% w/v SMP or WPC solution (1 g in 15 ml) was added to the retentate chamber and the system was centrifuged (maximally 3,000 g) in order to separate the permeate. Upon separation (2 hours), centrifugation was stopped 3 times in order to redissolve sedimented protein. Free metal analysis was carried out using the permeates after the ultrafiltration separation described above. These solutions were directly sprayed into the plasma of a plasma emission spectrometer as described above.

### Example 1A

Influence of pH on Metal Removal

Filtration experiments were carried out as described above at pH values between 1 and 7. The protein solutions were pre-incubated for 3 hours at set pH at room temperature prior to filtration and no sequestrants were added during this experiment.

It was found that, at pH 4.5-4.7, which corresponds to the pH of dairy spreads, about 6% copper and 0.5% iron is liberated, whereas 32% copper and 3.5% iron is in the free form at pH 3.5.

Similarly, filtration of WPC showed an increased amount of free copper at decreased pH. At pH 3, about 50% of the total copper level was liberated, whereas all the iron was bound. At pH around 1.25 70% of all copper was removed.

In skimmed milk powder free copper levels up to 25% were obtained already at pH 3 to 4.

In skimmed milk powder about 55 to 60% of iron is removed at pH 1.5.

In summary, ultrafiltration at decreased pH can be used to remove weakly bound copper from SMP and WPC, whereas part of the iron remains strongly bound. Part of the iron and half of the copper content is removed upon filtration at pH 3. Further improvement of copper removal is obtained at pH to as low as 1.25.

### Example 1B

Influence of EDTA at pH 7 on Metal Removal

Both SMP and WPC were ultrafiltered at pH 7 in the presence of a concentration series of EDTA, after a 15 minutes pre-incubation period, at room temperature. As the protein content in both powders differs considerably (37% versus 74%), the amount of EDTA is given in w/w on protein. Upon filtration the small metal-EDTA complexes were transported to the permeate. Although results are still expressed in “% free metals”, it is actually the metals liberated from protein that are measured. The amount of free copper present in SMP at EDTA <3% was below the detection limit of the element analysis.

It was found that high EDTA concentrations are required to start liberating copper (at >3% EDTA) and iron (at >10% EDTA) from SMP, whereas liberation of both metals from WPC starts at the lowest concentration dose (0.1%). At 13.5% w/w EDTA, 5% iron and 41% copper is removed from SMP whereas 30% and 65% is removed from WPC.

In order to improve the levels of metal removal, EDTA concentration and pre-incubation time and temperature were increased. It was found that an increased pre-incubation temperature slightly promotes the removal of both iron and copper. At 30% w/w EDTA, 25% iron and 54% copper is removed at room temperature, whereas 39% and 67% are removed at 50° C. Also an extended pre-incubation time (overnight at 4° C.) has a small effect, as 41% iron and 61% copper is removed now. Increasing the EDTA concentration up to 90% w/w shows a continuous linear increase of the copper removal, whereas the removal of iron reaches a maximum level of about 40%. Similar results were obtained with WPC.

In summary, about 85% of copper and 40% of iron can be removed from both SMP and WPC in the presence of excess EDTA.

### Example 2

Chromatographic Removal of Metals

General Method

Four different chromatographic resins were tested batch-wise, for their ability to specifically bind metal ions from SMP and WPC. These resins include hydroxyapetite, sulphopropyl-, thiopropyl- and chelating Sepharose.

### Example 2A

Hydroxyapetite (HA)

Combined anion and cation exchange chromatography was performed using CHT ceramic HA Type II material from Biorad. This form of HA is a robust, chemically pure resin that can be re-used many times. About 10 g HA was washed 2 times with demineralised water and 3 times with 10 mM sodium phosphate pH 7 using a sintered glass filter. About 10 g of SMP or WPC in 200 ml of the phosphate buffer was incubated for 2 hours at room temperature with the washed HA. The solutions were gently shaken to avoid damage of the chromatographic resin. Finally, the proteins were separated from the chromatographic resin using the sintered glass filter, quickly frozen using CO₂-ice/acetone and freeze-dried.

It was found that HA can be used to remove both iron and zinc from SMP and WPC. The removal of these metals from SMP is comparable with the maximum level obtained using ultrafiltration in the presence of EDTA at pH 7, whereas the removal from WPC is slightly less compared with this ultrafiltration experiment.

### Example 2B

Sulphopropyl Sepharose (SP)

Cation exchange chromatography was carried out using SP-Sepharose Fast Flow from Amersham Biosciences. About 10 g SP was washed 2 times with demineralised water and 3 times with 10 mM sodium phosphate pH 7 using a glass filter. Exactly the same batch-wise procedure as described above for HA was applied for the SP-Sepharose.

It was found that as much as 70% of the total iron content of SMP was removed upon incubation with the SO₃ groups of SP Sepharose. This amount is about the same as the maximum amount of iron removal obtained using ultrafiltration in the presence of both EDTA and ascorbic acid at pH 5. The iron content of WPC is only reduced by 7%.

### Example 2C

Thiopropyl Sepharose (TP)

Covalent chromatography using an activated thiolated matrix was achieved using TP-Sepharose 6B from Amersham Biosciences. The Sepharose material was first activated into its sulphydryl form by incubation of 1 g TP in 4 ml of 0.5 M β-mercaptoethanol and 1 mM EDTA in 0.3 M sodium bicarbonate pH 8.4 for 40 minutes at room temperature. This material was washed with 400 ml 0.1 M acetic acid containing 0.5M NaCl and 100 ml demineralised water using a sintered glass filter. About 10 g of SMP or WPC in 150 ml demineralised water was incubated for 2 hours at room temperature with the activated and washed TP. The solutions were gently shaken to avoid damage of the chromatographic resin. The same batch-wise separation procedure was also carried out without the activation step with β-mercaptoethanol. Finally, the proteins were separated from the chromatographic resin using the sintered glass filter, quickly frozen using CO₂-ice/acetone and freeze-dried.

It was found that both TP Sepharose with and without the protecting 2-thiopyridyl group removes about 60-65% iron from SMP. These values are almost equal to the removal accomplished with SP Sepharose. Furthermore, 38% of total copper is removed from SMP if the free thiol material is used. No copper and iron is removed from WPC if TP Sepharose is used, whereas a moderate removal of these metals from WPC is accomplished upon incubation with the free sulphydryl form of TP Sepharose.

### Example 2D

Chelating Sepharose (CH)

Immobilised metal chelate affinity chromatography (IMAC) was carried out using CH-Sepharose Fast Flow from Amersham Biosciences. About 5 g CH was washed 3 times with demineralised water and 3 times with 50 mM sodium phosphate pH 7 using a sintered glass filter. About 10 g of SMP or WPC in 100 ml of the phosphate buffer was incubated for 3 hours at room temperature with the washed CH. The solutions were gently shaken to avoid damage of the chromatographic resin. Finally, the proteins were separated from the chromatographic resin using the sintered glass filter, quickly frozen using CO₂-ice/acetone and freeze-dried.

It was found that iron removal is again more easily accomplished from SMP proteins (25% removal) than from WPC (0% removal) whereas, for removal of copper, it is the other way round (11% versus 27%).

1. A process for the preparation of an edible emulsion having a reduced oxidative metal content which comprises an oil phase and an aqueous phase, the process comprising the steps of
(a) providing a starting material containing a protein or a protein material;
(b) removing the metal from the starting material; and
(c) using the product of step (b) to form an edible emulsion.

2. A process according to claim 1 in which the metal is selected from the group consisting of copper and iron.

3. A process according to claim 1 in which the protein is selected from the group consisting of milk proteins, soya protein, pea protein and combinations thereof.

4. A process according to claim 3 in which the protein is a milk protein and the starting material is selected from the group consisting of whole milk, whole milk powder, skimmed milk, skimmed milk powder, butter milk, butter milk powder, butter serum, butter serum powder, whey, whey powder, whey protein concentrate, whey protein isolate and sodium caseinate.

5. A process according to claim 1 in which the metal is removed from the starting material by filtration.

6. An edible emulsion obtainable by a process according to claim 1.

7. A food product comprising an edible emulsion according to claim 6.

8. A food product according to claim 7 selected from the group consisting of milk, cheese, yoghurt, cream, spreads, mayonnaise, dressings, sauces, ice cream and dairy alternative products.
